(19) United States
(12) Patent Application Publication
(10) Pub. No.: US 2005/0286358 A1
(43) Pub. Date: Dec. 29, 2005

(54) Optical disk device and optical disk processing method

(75) Inventors: Takayuki Mori, Hachioji-shi (JP); Minoru Yonezawa, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/157,802

(22) Filed: Jun. 22, 2005

(30) Foreign Application Priority Data
Jun. 25, 2004 (JP) 2004-188097

(51) Int. Cl. G11B 7/00

(52) U.S. Cl. 369/44.34; 369/44.25; 369/44.27

(57) ABSTRACT

An optical disk device of the invention comprises a pickup which obtains a reading signal by irradiating an optical disk having plural recording layers with laser beam, a generating unit which generates a focus error signal from the reading signal, a control unit which focuses the laser beam based on the focus error signal, a holding unit which holds changes in a focus drive signal for driving the objective lens in a focus direction and the focus error signal as history information, and a determining section which determines where the focus position exists within the plural recording layers of the optical disk based on the focus error signal, the focus drive signal and the history information.

### CROSS-REFERENCE TO RELATED APPLICATIONS

This application is based upon and claims the benefit of priority from prior Japanese Patent Application No. 2004-188097, filed Jun. 25, 2004, the entire contents of which are incorporated herein by reference.

### BACKGROUND OF THE INVENTION

1. Field of the Invention

The present invention relates to an optical disk device which handles an optical disk having plural recording layers, and more particularly to an optical disk device which identifies plural recording layers by referring to history information and an optical disk processing method.

2. Description of the Related Art

As is well known, such an optical disk as a digital versatile disc (DVD) has been prevalent as a digital recording medium and an optical disk device which plays back the optical disk is demanded to have a high reliability.

In such an optical disk device, a case of handling an optical disk having plural recording layers has been known. In this case, a focus of laser beam irradiated to the optical disk through an objective lens jumps between the respective recording layers as required.

Jpn. Pat. Appln. KOKAI Publication No. 2003-208720 has disclosed an optical disk device which detects a vertical position of an objective lens by comparing a reference voltage value of a focus drive signal acquired upon disk search with a voltage value of a focus drive signal after focus jump between L0 layer and L1 layer, thereby determining whether or not move between the L0 layer and the L1 layer is successful.

However, in the optical disk device of the Jpn. Pat. Appln. KOKAI Publication No. 2003-208720, the position of current laser beam focus cannot be identified until address information of the recording layer is read out and analyzed. Thus, there is such a problem that the identification result cannot be used for real time control such as the focus control.

### BRIEF SUMMARY OF THE INVENTION

According to one aspect of the present invention, there is provided an optical disk device comprising: a pickup configured to irradiate an optical disk having plural recording layers with laser beam through an objective lens and to read reflection light from the optical disk to output a reading signal; a focus error signal generating unit configured to generate a focus error signal based on the reading signal outputted from the pickup; a focus control unit configured to control the position of the objective lens in the focus direction based on the focus error signal generated by the focus error signal generating unit and to focus the laser beam to an arbitrary layer of the plural recording layers; a holding unit configured to hold changes in the focus drive signal for driving the objective lens in the focus direction and the focus error signal generated by the focus error signal generating unit as history information; a determining section configured to determine and output layer information indicating in which layer of the plural recording layers in the optical disk the focus position of the laser beam exists, based on the focus error signal, the focus drive signal and the history information held by the holding unit; and a control unit configured to record or reproduce information in/from a recording layer in the optical disk indicated by the layer information outputted from the determining section.

According to another aspect of the present invention, there is provided an optical disk processing method comprising: irradiating an optical disk having plural recording layers with laser beam through an objective lens and outputting a reading signal by reading reflection light from the optical disk; generating a focus error signal based on the reading signal: controlling the position of the objective lens in the focusing direction based on the focus error signal and focusing the laser beam to an arbitrary layer of the plural recording layers; holding changes in the focus drive signal and the focus error signal for driving the objective lens in the focusing direction as history information; determining and outputting layer information indicating in which layer of the plural recording layers in the optical disk the focus position of the laser beam exists, based on the focus error signal, the focus drive signal and the history information; and recording or reproducing information in/from the recording layer of the optical disk indicated by the layer information.

### BRIEF DESCRIPTION OF THE SEVERAL VIEWS OF THE DRAWING

FIG. 1 is a block diagram for explaining an optical disk device according to an embodiment of the present invention;

FIG. 2 is a diagram for explaining the detail of a pickup in the optical disk device according to the embodiment;

FIG. 3 is a block diagram for explaining a layer determining section in the optical disk device according to the embodiment;

FIG. 4 is a flow chart for explaining an example of layer determination processing operation of the optical disk device according to the embodiment;

FIG. 5 is a flow chart for explaining another example of the layer determination processing operation of the optical disk device according to the embodiment;

FIG. 6 is a diagram for explaining changes in a focus error signal and a focus drive signal when the focus position of the optical disk device according to the embodiment is moved;

FIG. 7 is a diagram for explaining changes in the focus error signal and focus drive signal when the focus position of the optical disk device according to the embodiment is moved;

FIG. 8 is a diagram for explaining changes in the focus error signal and focus drive signal when the focus position of the optical disk device according to the embodiment is moved; and

FIG. 9 is a diagram for explaining changes in the focus error signal and focus drive signal when the focus position of the optical disk device according to the embodiment is moved.

### DETAILED DESCRIPTION OF THE INVENTION

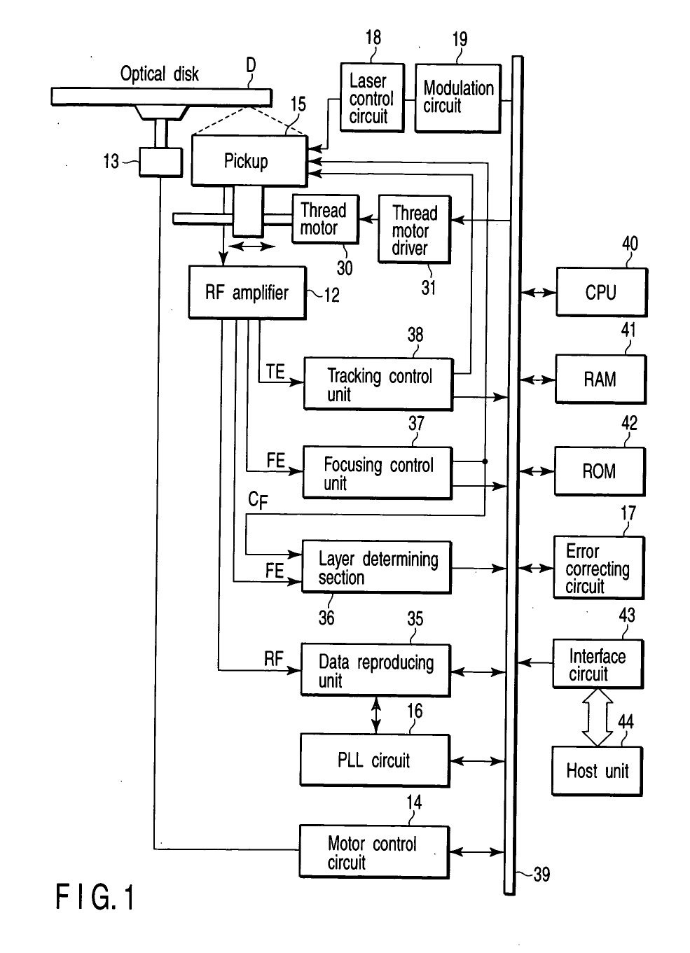

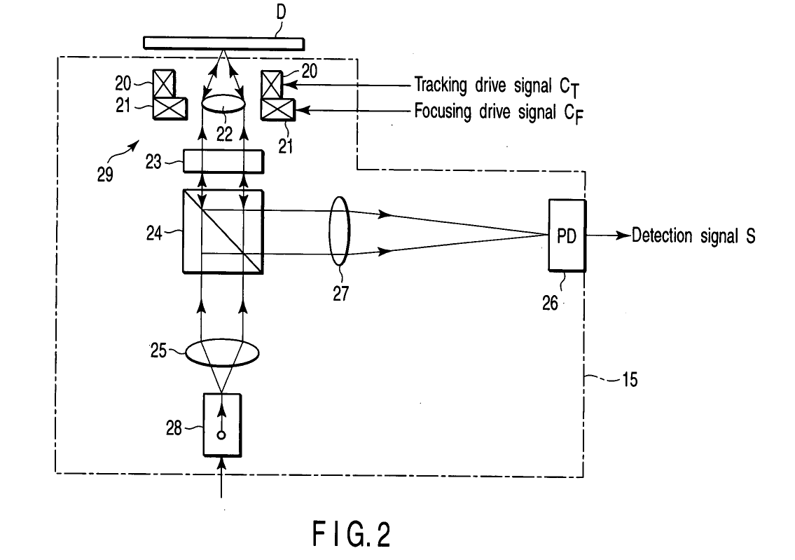

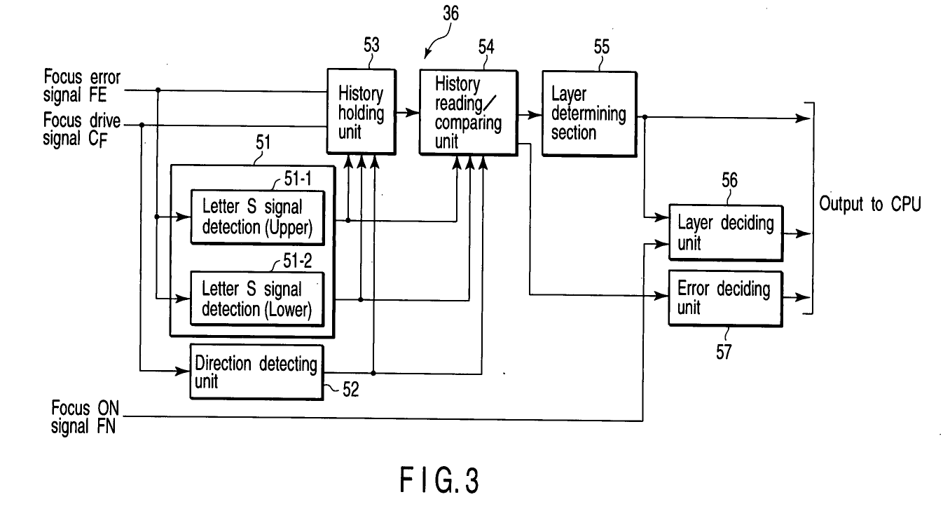

Hereinafter an embodiment of the present invention will be described in detail with reference to the drawings. FIG. 1 is a block diagram of an optical disk device according to the embodiment. FIG. 2 is a diagram showing the detail of a pickup in the optical disk device according to the embodiment. FIG. 3 is a block diagram of a layer determining section of the optical disk device according to the embodiment.

<Optical Disk Device>

(Structure and Operation)

The optical disk device of this embodiment is configured as shown in FIGS. 1 and 2. It is permissible to adopt an optical disk capable of recording user data or a read only optical disk as an optical disk D. This embodiment will be described about a recordable optical disk. The recordable optical disk includes a DVD-R, a DVD-RAM, a CD-R, a CD-RW and the like.

A land track and a groove track are formed spirally in the surface of the optical disk D. The optical disk D is rotated by a spindle motor 13. Recording or reproduction of information into or from the optical disk D is carried out by a pickup 15. The pickup 15 is connected to a thread motor 30 via a gear.

The thread motor 30 is controlled by a thread motor driver 31 connected to a data bus 39. A permanent magnet (not shown) is provided on a fixing unit of the thread motor 30 and by exciting a drive coil (not shown), the pickup 15 is moved in the radius direction of the optical disk D.

An objective lens 22 is provided on the pickup 15 as shown in FIG. 2. The objective lens 22 is movable in the focusing direction (direction of optical axis of the objective lens 22) by driving of a drive coil 21. Further, the objective lens 22 is movable in the tracking direction (direction perpendicular to the optical axis of the objective lens) by driving of the drive coil 20. Then, by moving the beam spot of the laser light, track jump can be executed as described later.

Referring to FIG. 1, a modulating circuit 19 executes 8-14 modulation (EFM) on user data supplied from a host unit 44 through an interface circuit 43 at the time of recording information and provides EFM data.

A laser control circuit 18 generates a write signal based on the EFM data supplied from the modulating circuit 19 at the time of recording information (when a mark is formed) and supplies it to a semiconductor laser diode 28. Further, the laser control circuit 18 supplies a read signal smaller than the write signal to the semiconductor laser diode 28 at the time of reading information.

The semiconductor laser diode 28 generates laser beam corresponding to a signal supplied from the laser control circuit 18. Laser beam projected from the semiconductor laser diode 28 is focused on the optical disk D through a collimator lens 25, a half prism 24, an optical system 23 and the objective lens 22. Reflection light from the optical disk D is introduced to a beam detector 26 through the objective lens 22, the optical system 23, the half prism 24 and a focusing lens 27.

The beam detector 26 is constituted of 4-division beam detecting cells and supplies signals A, B, C, D to an RF amplifier 12. The RF amplifier 12 supplies a tracking error signal TE of (A+D)−(B+C) to a tracking control unit 38, a focus error signal FE of (A+C)−(B+D) to a focusing control unit 37 and a layer determining section 36 and an RF signal of (A+D)+(B+C) to a data reproducing unit 35.

Then, the focusing control unit 37 generates a focus drive signal C_{F} based on the inputted focus error signal FE and outputs the signal to the focusing drive coil 21. Consequently, the laser beam is always just focused on a recording film of the optical disk D.

Further, the tracking control unit 38 generates a tracking drive signal CT based on the inputted tracking error signal TE and outputs it to the drive coil 20 in the tracking direction.

If the focus control and tracking control are carried out, changes in reflectivity are reflected upon a sum signal RF of output signals of the beam detecting cells in the beam detector 26 from a pit formed on the track of the optical disk D corresponding to recorded information. The signal RF is supplied to the data reproducing unit 35.

The data reproducing unit 35 reproduces recording data based on a reproduction clock signal from a PLL circuit 16. Further, the data reproducing unit 35 has a function for measuring the amplitude of the signal RF and the measured value is read out by a CPU 40.

When the objective lens 22 is controlled by the tracking control unit 38, the pickup 15 is controlled by controlling the thread motor 30 so as to place the objective lens 22 at an optimum position of the optical disk.

Further, the motor control circuit 14, the tracking control unit 38, the laser control circuit 18, the PLL circuit 16, the data reproducing unit 35, the focusing control unit 37 and the like can be constituted in a single LSI chip as a servo control circuit.

These circuits are controlled by the CPU 40 via the bus 39. The CPU 40 comprehensively controls the optical disk device based on an operation command provided from the host unit 44 via the interface circuit 43. The CPU 40 uses a RAM 41 as a working area and executes a predetermined operation based on an operation program recorded in the ROM 42.

Further, the layer determining section 36, as shown in FIG. 3, comprises a letter S signal detecting unit 51 (including an upper letter S signal detecting unit 51-1 and a lower letter S signal detecting unit 51-2) for receiving a focus error signal FE, a direction detecting unit 52 for receiving a focus drive signal C_{F} and a history holding unit 53 for receiving a focus error signal FE and a focus drive signal C_{F}.

The layer determining section 36 comprises a history reading/comparing unit 54 for receiving an output of the history holding unit 53, an output of the letter S signal detecting unit 51 and an output of the direction detecting unit 52, a layer determining section 55 for receiving an output of the history reading/comparing unit 54, a layer deciding unit 56 for receiving the layer determining section 55 and a focus ON signal FN and an error deciding unit 57 for receiving an output signal of the history reading/comparing unit 54.

Here, the letter S signal detecting unit 51 receives an inputted focus error signal FE, compares it with a threshold level and executes detection of the letter S signal. The threshold level is a fixed value or a value set by the CPU 40. The letter S signal detecting unit (upper) 51-1 detects a mountain side of the letter S signal, and the letter S signal detecting unit (lower) detects a valley side of the letter S signal.

The focus drive signal C_{F} is supplied by the focusing control unit 37 (or CPU 40) and the direction detecting unit 52 detects whether or not the focus position of the laser beam is approaching or leaving the optical disk D based on the focus drive signal C_{F}.

The history holding unit 53 stores in what order the detected letter S signal and direction are inputted using an incorporated shift register. That is, the detected focus error signal FE, focus drive signal C_{F}, the shape of the letter S signal detected by the letter S detecting unit 51, and the moving direction of the pickup 15 detected by the direction detecting unit 52 are held. The fetch timing (letter S signal detection timing and sampling timing) and capacity are arbitrary and depends on an accuracy required for reading the history.

The history reading/comparing unit 54 detects what layer is focused by data memorized in the history holding unit 53 sequentially. This detection is carried out by reading out previous move history held in the history holding unit 53 and comparing it with the shape of a letter S signal of a current focus error signal FE (whether inverted letter S signal or letter S signal).

The layer deciding unit 56 decides a focused layer based on a focus ON signal FN inputted from the focusing control unit 37 or the CPU 40 and a signal from the layer determining section 55 and outputs a determination result to the CPU 40.

The determination of a focused layer is carried out finally by the CPU 40, and the CPU 40 determines a focused layer using an output of the layer determining section 36.

<Layer Deciding Processing of Optical Disk Device>

### FIRST EXAMPLE

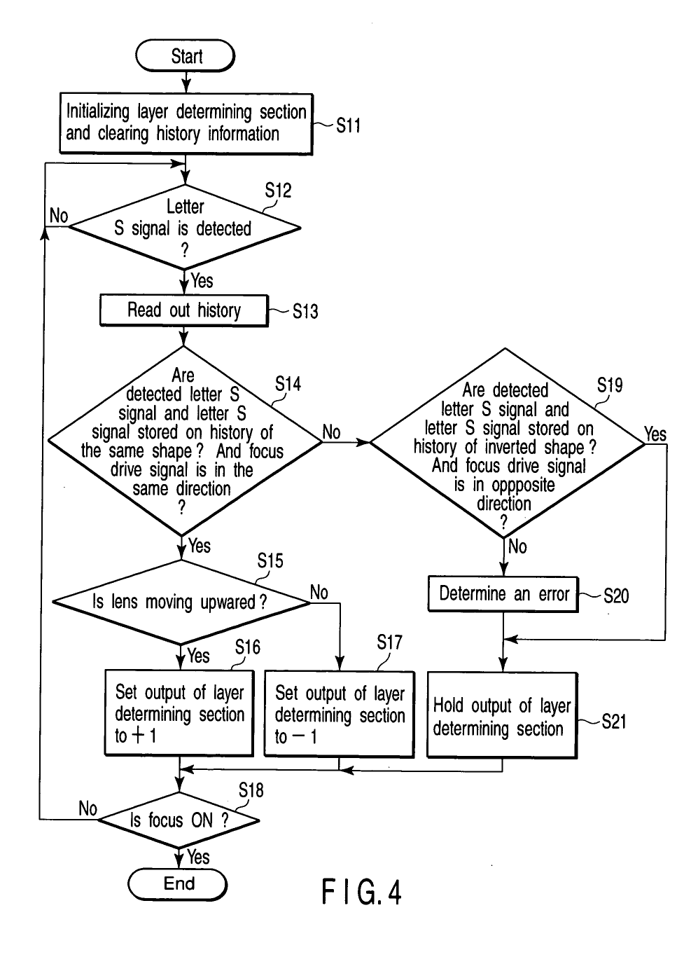

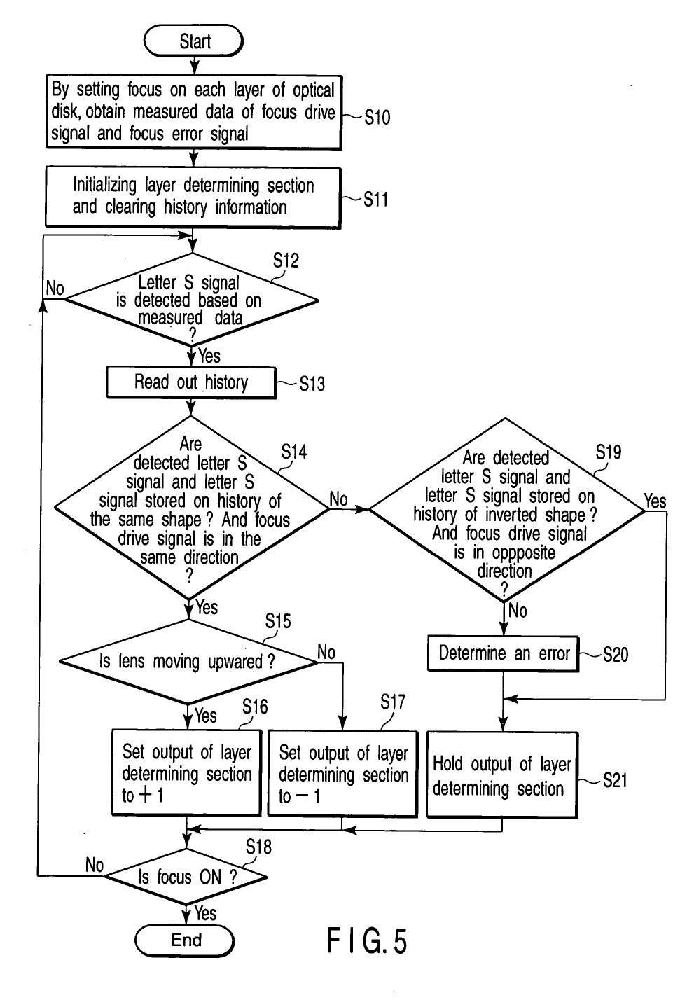

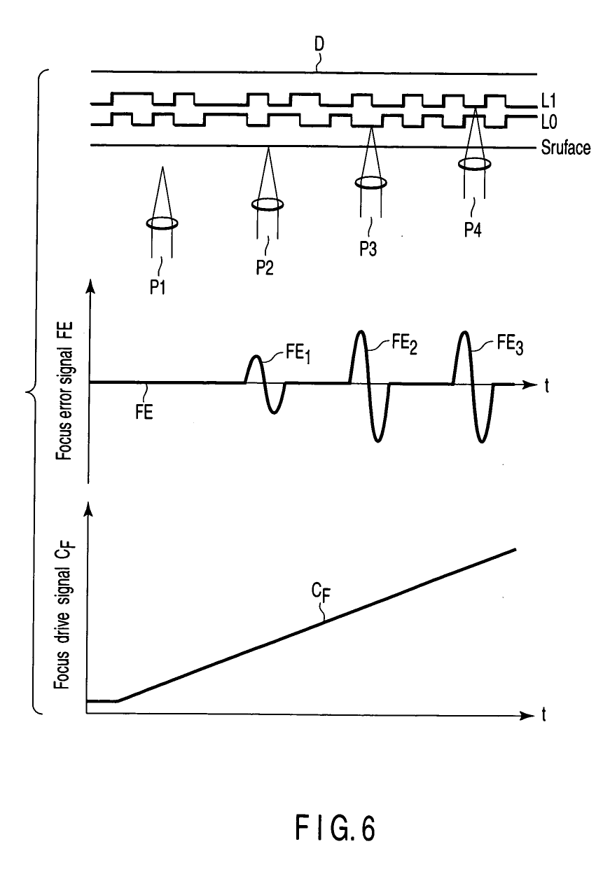

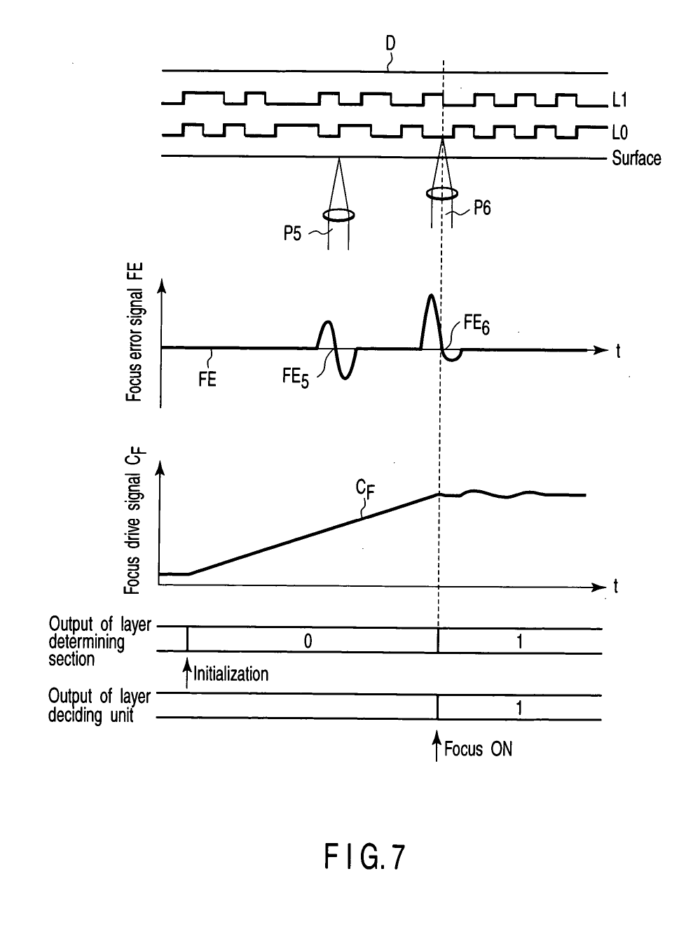

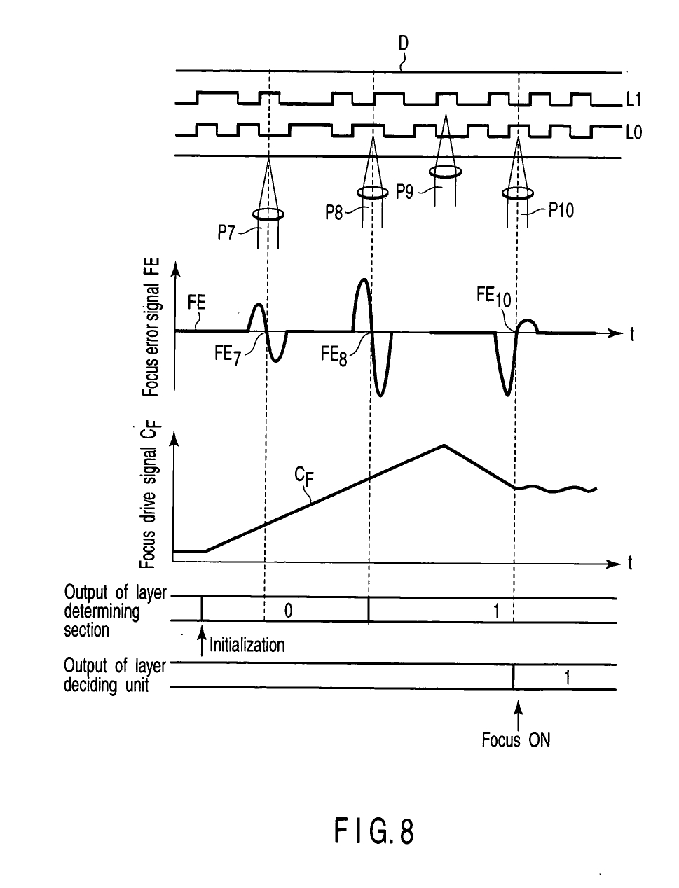

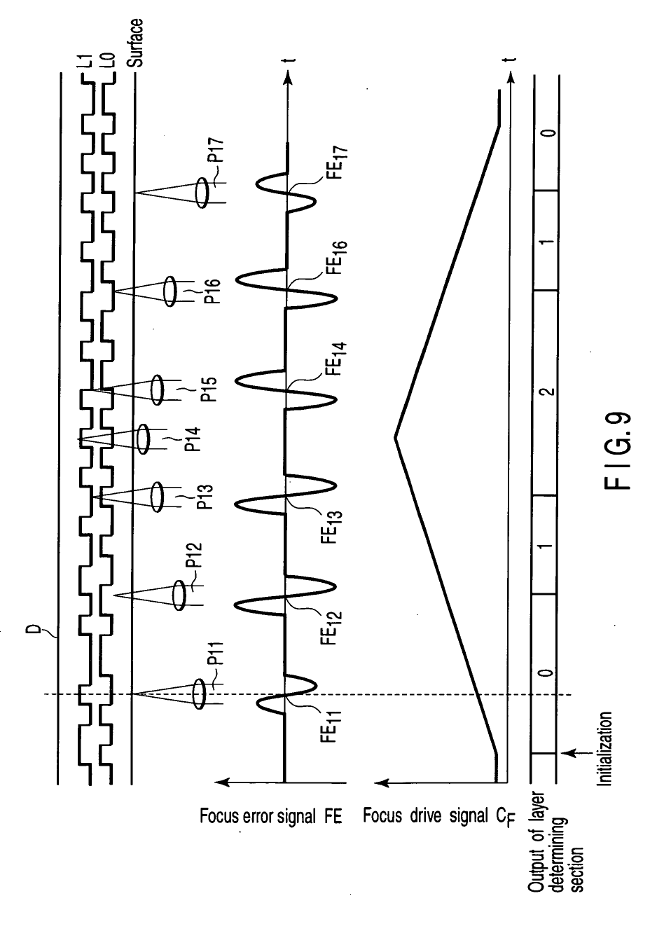

Next, the layer deciding processing of the optical disk device will be described in detail. FIG. 4 is a flow chart for explaining an example of layer determination processing operation of the optical disk device. FIG. 5 is a flow chart for explaining another example of the layer determination processing operation. FIG. 6 is a diagram for explaining changes in the focus error signal and focus drive signal when the focus position of the optical disk device is moved. FIG. 7 is a diagram for explaining changes in the focus error signal and focus drive signal when the focus position of the optical disk device is moved. FIG. 8 is a diagram for explaining changes in the focus error signal and focus drive signal when the focus position of the optical disk device is moved. FIG. 9 is a diagram for explaining changes in the focus error signal and focus drive signal when the focus position of the optical disk device is moved.

The optical disk device determines which layer of the plural recording layers is focused by current layer beam by the operation of the layer determining section 36 considering changes (history) in the focus error signal FE and focus drive signal C_{F}.

First, if the objective lens 22 of the pickup 15 is moved by control of the focusing control unit 37 under the control of the CPU 40, the focus position begins to move toward the optical disk surface and in this while, the value of the layer determining section 36 is initialized so as to clear the history information (S11). Then, the layer determining section 36 loads a value set by the CPU 40. For example, when moving upward from the bottommost portion, “0” is set up; when it is currently located on the first layer, “1” is set up; and when it is currently located on the second layer, “2” is set up. The history holding unit 53 is cleared.

Next, the pickup 15 is moved according to the focus drive signal C_{F}. If the letter S signal is detected from the focus error signal FE (S12), a previous letter S shape and focus drive direction are obtained from the history holding unit 53 (S13).

Whether or not the shape of the letter S signal detected from the focus error signal FE currently give to the layer determining section 36 and the shape of a previous letter S signal held by the history holding unit 53 are of the same shape is determined.

As for this determination, as described in FIG. 6, whether a detected letter S signal is an inverted letter S signal (like, for example, signals FE₁, FE₂, FE₃) or a normal letter S signal (like, for example, a signal FE₁₀ in FIG. 8, a signal FE₁₄ in FIG. 9, a signal FE₁₆ or a signal FE₁₇). For example, if the inverted letter S signal→the inverted letter S signal or the letter S signal→the letter S signal come in this order, it is determined that it is of the same shape. If the inverted letter S signal→the letter S signal or the letter S signal→the inverted letter S signal come in this order, it is determined that it is of inverted shape. Further, whether or not the focus drive signal C_{F} is oriented in the same direction is determined.

Here if the history reading/comparing unit 54 determines that the letter S signal is of the same shape and the focus drive signal C_{F} indicates the same direction (S14), it is determined that the focus position is moved to a next layer.

Further, if the direction detecting unit 52 determines that the focus position is moved upward (S15), the layer determining section 36 outputs +1 receiving an output of the history reading/comparing unit 54 (S16).

This falls under a case where if for example, an example of the output of the layer determining section 36 is defined so that the surface of the disk is “0”, the first recording layer L0 is “1” and the second recording layer L1 is “2”, the output is changed from “1” of the first recording layer L0 to “2” of the second recording layer L1 with the output being “+1”.

If it is determined that the focus position is moving downward by the direction detecting unit 52 in step S15 (S15), the layer determining section outputs −1 (S17). This falls under a case where the output is changed from “1” of the first recording layer L0 to “0” of the disk surface with the output being “−1”.

If NO occurs in step S14 and a detected letter S signal is in an inverted shape of a previous letter S signal and the focus drive signal C_{F} indicates an opposite direction (S19), it is determined that although the focus position surpassed a layer, it has returned to that layer and the layer determining section 36 maintains the output (S21).

If the detected letter S signal and the previous letter S signal are of the same shape while the focus drive signal C_{F} indicates an opposite direction or the letter S signal is of inverted shape while the focus drive signal C_{F} indicates the same direction, it is determined that noise is detected by the error deciding unit 57 and the CPU 40 is informed. At this time, the layer determining section 36 maintains its output value (S21).

If the focus ON signal FN is received (S18) at this stage, the layer deciding unit 56 notifies the CPU 40 of an output value of the current layer determining section 55 as a focused layer. Unless the focus ON signal FN is received, the layer deciding unit 56 waits until the letter S is inputted again (S12).

The layer determining processing with the layer determining section 36 of the optical disk device is performed with the focus error signal FE and the focus drive signal C_{F} based on such a history of each signal as first, a focus position exists in the first recording layer. Thereafter, the objective lens 22 moves upward and then “inverted letter S signal” (of the same shape) is detected again from the “inverted letter S signal” in the first recording layer. As a consequence, the layer determination of the focus position can be carried out even in case where the focus position reciprocates like “disk surface” →“first recording layer”→“second recording layer”→“first recording layer”.

(Signal Change When the Pickup is Moved)

Next, an example of the focus error signal FE and the focus drive signal C_{F} when the focus position of the laser beam is changed will be described.

FIG. 6 shows the focus error signal FE and the focus drive signal C_{F} when the pickup 15 is approached to a two-layer optical disk. A position P1 of the objective lens 22 indicates a condition in which the objective lens 22 is apart from the optical disk D and no focus error signal FE is detected.

At the position P2 of the objective lens 22, irradiated beam is focused on the surface of the optical disk D and a letter S focus error signal FE₁ is detected. At the position P3 of the objective lens 22, irradiated beam is focused on a recording layer L0 of the optical disk D and a focus error signal FE₂ is detected. At the position P4 of the objective lens 22, irradiated beam is focused on a recording layer L1 of the optical disk D and a focus error signal FE₃ is detected. As the value of the focus drive signal C_{F} increases, the objective lens 22 approaches the optical disk D.

If the focus drive signal C_{F} decreases although not shown in FIG. 6, the objective lens 22 leaves the optical disk D. If the objective lens 22 is at the position P4, the objective lens 22 moves from the position P4 to the position P1 step by step. Accompanied by this, inverted signals of the focus error signal are detected successively from the focus error signal FE₃ to the signal FE₁.

Next, FIG. 7 shows an example in which the objective lens 22 approaches the optical disk D, focusing on the first layer. When focusing is started, the layer determining section 55 is initialized. In FIG. 7, “0” is loaded.

As the focus drive signal C_{F} increases, the objective lens 22 approaches the optical disk D. Beam irradiated when the objective lens 22 is at a position P5 is focused on the surface of the optical disk D so that a focus error signal FE₅ is detected. At this time, the layer determining section 55 does not count up because the beam is focused on the surface of the optical disk D.

Subsequently, beam irradiated when the objective lens 22 is at a position P6 is focused on a recording layer L0 of the optical disk D and a focus error signal FE₆ is detected. At this time, it is determined that the focus reaches a recording layer L0 in detection of this focus error signal FE₆ because the history indicates that the surface of the optical disk D is previously focused and the layer determining section 55 counts up.

If focusing is performed at this position, the focus drive signal C_{F} is controlled so that the focus never goes out and the focus error signal FE₆ becomes letter S signal having only mountains because the objective lens 22 is not moved. Consequently, it is determined that the output of the layer deciding unit 56 is focused on the first layer and for example, “1” is outputted.

Although FIG. 7 indicates an ideal waveform, there is such a possibility that larger valleys are detected in the focus error signal FE₆ in actual operation. In this case, it is determined that the first layer is focused.

FIG. 7 refers to the first recording layer. If the pickup approaches the optical disk D and focuses on the second layer, the same waveform as the focus error signal FE₆ is attained at the position P4 of the objective lens 22 shown in FIG. 6 through the focus error signals FE₅, FE₆. By identifying this trajectory with a shift register and history determination, it is determined that the second recording layer L1 is focused by the history reading/comparing unit 54.

Although FIG. 7 mentions that the objective lens 22 approaches the surface of the optical disk D and after that focuses on the recording layer, this situation is capable of meeting a case where the recording layer L0 is already focused and then a jump to the recording layer L1 is made. In this case, the layer determining section 55 loads for example, “1” for initialization.

Further, this situation is capable of meeting a case where the recording layer L1 is already focused and a jump to the recording layer L0 is made. In this case, the layer determining section 55 loads, for example, “2” for initialization.

Next, FIG. 8 shows a diagram showing respective signals when the focus passes the first layer and after that, returns to and is made on the first layer.

When the focus is started, the layer determining section 55 is initialized. In FIG. 8, the layer determining section 55 loads, for example, “0”.

As the focus drive signal C_{F} increases, the objective lens 22 approaches the optical disk D. Beam irradiated when the objective lens 22 is at a position P7 is focused on the surface of the optical disk D and a focus error signal FE₇ is detected. At this time, the layer determining section 55 does not count up because the focus is on the surface of the optical disk D.

Subsequently, beam irradiated when the objective lens 22 is at a position P8 is focused on the recording layer L0 of the optical disk D and a focus error signal FE₈ is detected. At this time because the history indicates that surface of the optical disk D is previously focused and the focus reaches the recording layer, the layer determining section 55 counts up.

The focus drive signal C_{F} further increases, so that the focus passes the recording layer L0 with the objective lens 22 located at a position P9. After that, by decreasing the focus drive signal C_{F}, the objective lens 22 is moved to a position P10 and a focus error signal FE₁₀ is detected.

Because this focus error signal FE₁₀ is in an inverted shape of previously detected letter S and the focus drive signal C_{F} indicates an opposite direction to a previously detected direction, it is determined that the focus is returned to the recording layer L0 and the layer determining section 55 holds a counter value.

If focusing is made at this position, the focus drive signal C_{F} is controlled not to be go out of focus and the focus error signal FE₁₀ turns to a letter S signal composed of only mountains because the objective lens 22 is not moved any more. Consequently, the layer determining section 55 determines that the first layer is focused.

FIG. 8 indicates an ideal waveform and thus, there is such a possibility that a larger valley may be detected in the focus error signal FE₁₀ in actual operation. In this case, it is determined that the first layer is focused. FIG. 8 refers to the first recording layer L0 and a second recording layer L1 can be met in the same manner.

If the objective lens 22 approaches the optical disk D, passes the first and second layers and then returns back so that focusing is made on the second layer, after the focus error signals FE₇, FE₈, the same waveform as the focus error signal FE₈ is produced when the objective lens 22 is at a position P4 as shown in FIG. 6. By tracing this trajectory using the history reading/comparing unit 54, it is determined that the second layer is focused.

FIG. 8 describes that the objective lens 22 approaches the surface and after that, the recording layer is focused. With this condition, the recording layer L0 is already focused, making it possible to meet an operation of jumping to the recording layer L1. In this case, at the time of initialization, the layer determining section 55 loads, for example, “1”.

Further, the recording layer L1 is already focused, making it possible to meet an operation of jumping to the recording layer L0. In this case, for initialization, the layer determining section 55 begins with loading for example, “2”.

Next, as an example of the operation, FIG. 9 shows respective signals when the focus starts from the surface of the optical disk D, passing the first layer once and reaching the second layer, and returns to the first layer and then the surface of the optical disk D.

In this case like the cases of FIGS. 6 to 8, the focus is made on the surface of the optical disc D when the objective lens 22 is at a position P11 while an inverted letter S signal FE₁₁ is detected with the focus error signal FE, and the focus is made on the first recording layer L0 when the objective lens 22 is at a position P12 while an inverted letter S signal FE₁₂ is detected with the focus error signal FE and the focus is made on the second recording layer L1 when the objective lens 22 is at a position P13 while an inverted letter S signal FE₁₃ is detected with the focus signal FE.

Further, the focus passes the second recording layer L1 when the objective lens 22 is at a position P14, and the focus is made on the second recording layer L1 when the objective lens 22 is at a position P15, while a letter S signal FE₁₄ is detected with the focus signal FE. The focus is made on the first recording layer L0 when the objective lens 22 is at a position P16, while a letter S signal FE₁₆ is detected with the focus signal FE. Further, the focus is made on the surface of the optical disk D when the objective lens 22 is at a position P17, while a letter S signal FE₁₇ is detected with the focus signal FE and then, the output of the layer determining section 36 returns to “0” again.

According to the optical disk device described above, by comparing the shapes of the letter S signal and inverted letter S signal based on the history of the focus error signal FE and the focus drive signal C_{F}, layer determination can be performed securely without mistake even if the focus reaches the second recording layer and passes the second recording layer to execute over-shoot and then returns to the second recording layer.

That is, the above-described optical disk device executes the layer determination when the focus position is brought in one way and back and when the objective lens 22 is moved and the focus position of the laser beam starts from the surface of the optical disk D and reaches the first recording layer and the second recording layer and further returns from the second recording layer to the first recording layer and the surface of the optical disk D, the output of the determining section changes from “0”→“1”→“2”→“1”→“0”, so that the layer at the focus position is determined considering the history of the layer determination up to then.

The optical disk device of this embodiment recognizes a current focus position in plural recording layers corresponding to changes (history) of the focus drive signal C_{F} and the focus error signal FE. That is, the changes (history) in the focus drive signal C_{F} and the focus error signal FE refer to recognizing that the focus position continues to move upward up to now and currently is moving upward when the polarity of the focus drive signal C_{F} keeps “positive”. As for the focus error signal FE, it refers to recognizing that detection of “inverted letter S signal” continues like “inverted letter S signal”,→“inverted letter S signal”→“inverted letter S signal”.

Without recognizing that a current focus position exists in, for example, the first recording layer based on instantaneous values of the focus drive signal C_{F} and the focus error signal FE, the layer determination is carried out based on continuous history of the focus drive signal C_{F} and the focus error signal FE, for example, that first, the focus position exists at the first recording layer, and after that the objective lens 22 moves upward and “inverted letter S signal” is detected from “inverted letter S signal” of the first recording layer, so that such a layer determination that, for example, a current focus position exists in the second recording layer can be carried out.

Because the layer of the focus position is determined based on the history of the focus drive signal C_{F} and the focus error signal FE, even if the focus position goes in one way and back like for example, the surface of the disk→the first recording layer→the second recording layer→the first recording layer, identification processing for a layer in which the focus is made can be carried out securely.

### SECOND EXAMPLE

The second example provides an optical disk device capable of detecting the letter S signal securely by placing the focus on each layer of each optical disk D and obtaining measured data of the focus drive signal C_{F} and the focus error signal FE.

That is, the optical disk D does not always control the focus drive signal C_{F} uniformly and the focus drive signal C_{F} and the focus error signal FE are not always detected, but an optical disk D has its inherent characteristic. Thus, each time when a DVD is stored in the disk holder, as described in FIG. 9, the focus position is moved to each layer of the optical disk D successively and at that time, measured values of the focus drive signal C_{F} and the focus error signal FE inherent of the optical disk D are obtained and the measurement result is made useful for the layer determination processing.

Each time when the optical disk D is stored in the disk holder as shown in the flow chart of FIG. 5, the focusing control unit 37 controls laser beam, so that the focus position of laser beam starts from the surface of the optical disk D and reaches the first recording layer and the second recording layer and further changes from the second recording layer to the first recording layer and the surface of the optical disk D (S10).

When the pickup 15 returns to the surface of the optical disk D again, detection of the inverted letter S signal and letter S signal which are changes of the focus error signal FE is memorized as measured data and this measured data is used for detecting subsequent inverted letter S signal and letter S signal.

By using the recorded measured data in step S12, even a minute difference in the characteristic among optical disks can be met accurately.

That is, because using the measured data enables generation timing of the inverted letter S signal, magnitude of a signal and the like to be registered precisely, particularly the focus error signal can be detected accurately based on the measured data (S12). In a processing of the flow chart of FIG. 5, description of common portions as FIG. 4 is omitted.

The processing of storing the measured data by feeding the focus position from the surface of the optical disk D to a deep recording layer is preferred to be automatically carried out by a CPU 40, a RAM 41 or the like only to obtain the measured data. Further, the measured data can be used for deciding a control amount upon layer jump or the like.

As described above in detail, although the present invention can be achieved in various embodiments by those skilled in the art, it is easy for those skilled in the art to image various modifications and the present invention can be applied to various examples even by those having no special inventive capacity. Therefore, the present invention extends to a wide range not inconsistent with the disclosed principle and novel features and is not restricted to the above-described embodiments.

The matching of an output of the layer determining section 36 with each of the plural recording layers of the optical disk D described above is just an example and the present invention is not restricted to this, but needless to say, various settings are enabled.

1. An optical disk device comprising:
a pickup configured to irradiate an optical disk having plural recording layers with laser beam through an objective lens and to read reflection light from the optical disk to output a reading signal;
a focus error signal generating unit configured to generate a focus error signal based on the reading signal outputted from the pickup;
a focus control unit configured to control the position of the objective lens in the focus direction based on the focus error signal generated by the focus error signal generating unit and to focus the laser beam to an arbitrary layer of the plural recording layers;
a holding unit configured to hold changes in the focus drive signal for driving the objective lens in the focus direction and the focus error signal generated by the focus error signal generating unit as history information;
a determining section configured to determine and output layer information indicating in which layer of the plural recording layers in the optical disk the focus position of the laser beam exists, based on the focus error signal, the focus drive signal and the history information held by the holding unit; and
a control unit configured to record or reproduce information in/from a recording layer in the optical disk indicated by the layer information output from the determining section.

2. An optical disk device according to claim 1, wherein the determining section is configured to detect an inverted letter S signal and a letter S signal which are changes in the focus error signal and to determine the layer information with the inverted letter S signal and letter S signal in the history information.

3. An optical disk device according to claim 1, wherein the focus control unit is configured to control the focus of the objective lens upon a predetermined recording layer of the optical disk based on the focus drive signal, the focus error signal and the layer information.

4. An optical disk device according to claim 1, wherein, the determining section is configured to, when the focus position of the laser beam reaches a first recording layer and second recording layer from the surface of the optical disk and returns to the first recording layer and the surface of the optical disk from the second recording layer, store detection of inverted letter S signal and letter S signal, which are changes in the focus error signal, as measured data and use the measured data upon subsequent detection of the inverted letter S signal and letter S signal.

5. An optical disk device according to claim 4, wherein the determining section is configured to move the objective lens to move the focus position of the laser beam only to obtain the measured data.

6. An optical disk device according to claim 1, wherein, the determining section is configured to, when the objective lens is moved so that the focus position of the laser beam reaches the first recording layer and the second recording layer from the surface of the optical disk and further, returns to the first recording layer and the surface of the optical disk from the second recording layer, carry out the layer determination of the focus position considering the history of previous layer determination.

7. An optical disk processing method comprising:
irradiating an optical disk having plural recording layers with laser beam through an objective lens and outputting a reading signal by reading reflection light from the optical disk;
generating a focus error signal based on the reading signal:
controlling the position of the objective lens in the focusing direction based on the focus error signal and focusing the laser beam to an arbitrary layer of the plural recording layers;
holding changes in the focus drive signal and the focus error signal for driving the objective lens in the focusing direction as history information;
determining and outputting layer information indicating in which layer of the plural recording layers in the optical disk the focus position of the laser beam exists, based on the focus error signal, the focus drive signal and the history information; and
recording or reproducing information in/from the recording layer of the optical disk indicated by the layer information.

8. An optical disk processing method according to claim 7, wherein the determining and outputting the layer information detects inverted letter S signal and letter S signal which are changes in the focus error signal and determines the layer information with the inverted letter S signal and letter S signal in the history information.

9. The optical disk processing method according to claim 7, wherein the generating the focus error signal controls the focus of the objective lens upon a predetermined recording layer of the optical disk based on the focus drive signal, the focus error signal and the layer information.

10. An optical disk processing method according to claim 7, wherein, when the focus position of the laser beam reaches a first recording layer and second recording layer from the surface of the optical disk and returns to the first recording layer and the surface of the optical disk from the second recording layer, the determining and outputting of the layer information stores detection of inverted letter S signal and letter S signal, which are changes in the focus error signal, as measured data and using the measured data upon subsequent detection of the inverted letter S signal and letter S signal.

11. An optical disk processing method according to claim 10, wherein the determining and outputting of the layer information moves the objective lens to move the focus position of the laser beam only to obtain the measured data.

12. An optical disk processing method according to claim 7, wherein, when the objective lens is moved so that the focus position of the laser beam reaches the first recording layer and the second recording layer from the surface of the optical disk and further, returns to the first recording layer and the surface of the optical disk from the second recording layer, the determining and outputting of the layer information carries out the layer determination of the focus position considering the history of previous layer determination.
